(19) United States
(12) Patent Application Publication
(10) Pub. No.: US 2009/0112943 A1
(43) Pub. Date: Apr. 30, 2009

(54) COMPUTER READABLE MEDIUM, INFORMATION MANAGEMENT METHOD AND INFORMATION MANAGEMENT APPARATUS

(75) Inventor: Yoshiharu SUZUKI, Kawasaki-shi (JP)

Correspondence Address: SUGHRUE-265550, 2100 PENNSYLVANIA AVE. NW, WASHINGTON, DC, 20037-3213, US

(73) Assignee: FUJI XEROX CO., LTD., Tokyo (JP)

(21) Appl. No.: 12/135,777

(22) Filed: Jun. 9, 2008

(30) Foreign Application Priority Data
Oct. 31, 2007 (JP) 2007-283148

(51) Int. Cl. G06F 12/00; G06F 17/30

(52) U.S. Cl. 707/203; 707/E17.007

(57) ABSTRACT

A computer readable medium storing a program causing a computer to execute a process for managing an electronic information group which includes a first piece and a second piece of electronic information, the process includes monitoring state information indicating a state of the first piece of electronic information; determining that a version of the electronic information group is updated when the state indicated by the state information is changed; judging whether the second piece of electronic information is included in the electronic information group which has the updated version or not, when determining that the version of the electronic information group is updated; and applying the judgment result to state information indicating a state of the second piece of electronic information.

### CROSS-REFERENCE TO RELATED APPLICATIONS

This application is based on and claims priority under 35 USC 119 from Japanese Patent Application No. 2007-283148 filed Oct. 31, 2007.

### BACKGROUND

The present invention relates to a computer readable medium, an information management method and an information management apparatus.

### BRIEF DESCRIPTION OF THE DRAWINGS

Exemplary embodiment(s) of the present invention will be described in detail based on the following figures, wherein:

FIG. 1 is a diagram illustrating an example of a hardware configuration of a computer constituting an information management apparatus according to an exemplary embodiment of the invention.

FIG. 2 is a functional block diagram illustrating an information management apparatus according to an exemplary embodiment of the invention.

FIG. 3 is a diagram illustrating an example of a setting screen for setting condition information to electronic information.

FIG. 4 is a flowchart illustrating an operation example of an information management apparatus according to an exemplary embodiment of the invention.

FIG. 5 is a diagram illustrating an electronic information group.

FIG. 6 is another diagram illustrating an electronic information group.

FIG. 7 is another diagram additionally illustrating an electronic information group.

FIG. 8 is a diagram illustrating a display example in case of applying a judgment result by a judgment unit to plural main documents.

FIG. 9 is a diagram illustrating a display example in case of applying a judgment result by a judgment unit, to an electronic information group including plural attached documents.

### SUMMARY

A computer readable medium storing a program causing a computer to execute a process for managing an electronic information group which includes a first piece and a second piece of electronic information, the process includes monitoring state information indicating a state of the first piece of electronic information; determining that a version of the electronic information group is updated when the state indicated by the state information is changed; judging whether the second piece of electronic information is included in the electronic information group which has the updated version or not, when determining that the version of the electronic information group is updated; and applying the judgment result to state information indicating a state of the second piece of electronic information.

### DETAILED DESCRIPTION

Hereinafter, a best mode for carrying out the invention (hereinafter, referred to as exemplary embodiment) will be described with reference to the drawings.

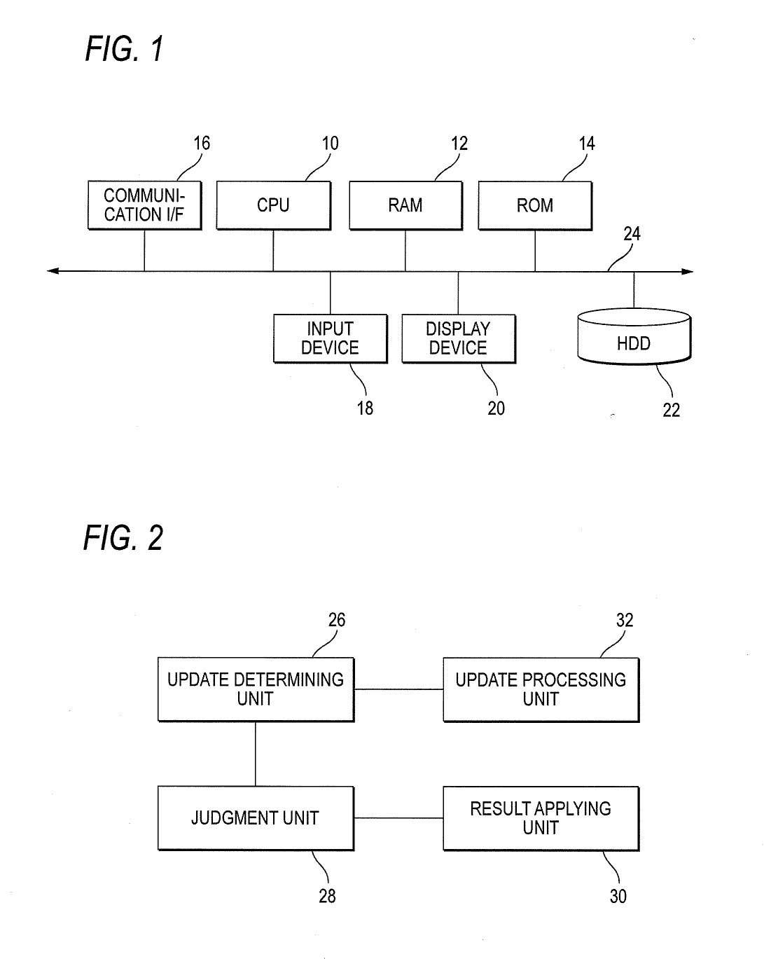

FIG. 1 shows an example of a hardware configuration of a computer constituting an information management apparatus according to the invention. As shown in FIG. 1, the information management apparatus includes a central processing unit (CPU) 10, a random access memory (RAM) 12, a read-only memory (ROM) 14, a communication interface 16, an input device 18, a display device 20, and a hard disk drive (HDD) 22, which are connected to one another by a bus 24.

The CPU 10 controls operation of units on the basis of control programs stored in the RAM 12 or the ROM 14. The RAM 12 functions mainly as a work area for the CPU 10.

The communication interface 16 includes an appropriate interface such as a USB (universal serial bus) port and a network port, which is used for the CPU 10 to transmit and receive data to and from an external device through communication section such as a network.

The input device 18 includes a keyboard, a pointing device, and the like, which is used for a user to input instruction of operation or the like.

The display device 20 includes a liquid crystal display and the like, which displays electronic information and management information thereof.

The hard disk drive 22 is a mass storage device, in which various kinds of data for processes (described later) are stored.

FIG. 2 shows a functional block diagram of the information management apparatus according to an exemplary embodiment of the invention. As shown in FIG. 2, the information management device includes an update determining unit 26, a judgment unit 28, a result applying unit 30, and an update processing unit 32.

The update determining unit 26 includes, for example, a CPU 10 and a program for controlling a process operation of the CPU 10. The update determining unit 26 monitors state information indicating a state of partial electronic information included in an electronic information group including pieces of electronic information, and determines that a version of the electronic information group is updated when the state of the partial electronic information is changed. In this case, the electronic information includes electronic documents (document data), image data, audio data, source codes of programs, executable format program, and the like, and has the state information indicating a state of the electronic information. The partial electronic information is not particularly limited, and is one or more pieces of electronic information to determine the version of the electronic information group. The state information includes version information of the electronic information, valid term information, information about deleting the electronic information, and the like. The change of the state of the electronic information indicated by the state information means update of a version of electronic information, expiration of valid time, or deletion of the electronic information.

The judgment unit 28 includes, for example, a CPU 10 and a program for controlling a process operation of the CPU 10. When the update determining unit 26 determines that the version of the electronic information group is updated, the judgment unit 28 judges whether or not another piece of electronic information included in the electronic information group before updating the version is still included in the electronic information group after updating the version. In the present example, condition information, which allows the another piece of electronic information not to be included in the electronic information group, is set in the another piece of electronic information and the judgment unit 28 judges whether or not the another piece of electronic information is still included in the electronic information group based on the condition information. The condition information may be set, for example, on the basis of the state of the partial electronic information, thereby changing the state of the partial electronic information. So, when it is judged that the version of the electronic information group is updated, it is determined whether the another piece of electronic information is still included in the electronic information group according to the change in state of the partial electronic information.

The result applying unit 30 includes, for example, a CPU 10 and a program for controlling a process operation of the CPU 10, and applies the judgment result of the judgment unit 28 to the state of the another piece of electronic information. Accordingly, when it is judged that the another piece of electronic information is not included in the electronic information group, the state information of the another piece of electronic information is changed on the basis of the condition information. For example, when expiration of a valid term is preset in the condition information, the another piece of electronic information is changed to be expired. When deletion is preset therein, the another piece of electronic information is deleted and state information about the deletion is created. The process that the result applying unit 30 applies the judgment result of the judgment unit 28 to the state of the another piece of electronic information, that is, the change of the state of the another piece of electronic information is displayed by the display device 20, thereby informing a user.

The update processing unit 32 includes, for example, a CPU 10 and a program for controlling a process operation of the CPU 10, and changes a state of electronic information on the basis of instruction information input from the input device 18 by a user. The changes includes, for example, update of a version of electronic information, deletion of electronic information, and the like. In case of changing the electronic information, the update processing unit 32 also changes the state information of the electronic information. In case of expiration of a valid term, the update process unit 32 creates state information about the expiration of the valid term at the time when the term expires, with reference to the term preset in the state information. For example, when the version of the electronic information is updated, when the valid term expires, or when the electronic information is deleted, the update processing unit 32 creates state information about the updated version, state information about the expiration of the valid term, or state information about the deletion. In any case, the state information is output to the update determining unit 26.

The aforementioned constituent elements are distributed and disposed in plural devices, which may be connected to one another by communication section. In addition, the information management apparatus may be connected to the plural devices by communication section, thereby cooperating with one another.

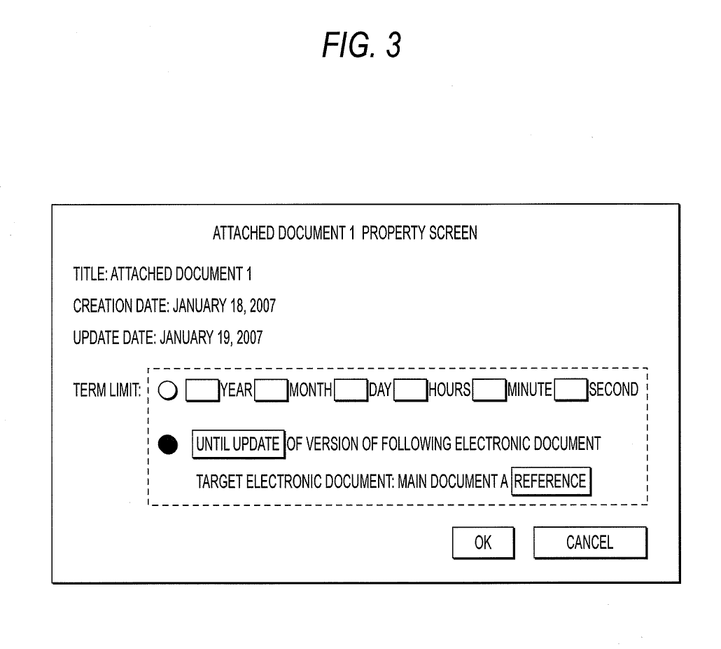

FIG. 3 shows an example of a setting screen for setting condition information to electronic information. As shown in FIG. 3, an attached document 1 (the another piece of electronic information) is displayed as a setting target in a title column, and a creation date and an update date of a setting content are also displayed. The setting content of condition information is a term limit (valid term), in which (i) specific date and time or (ii) conditions except for date and time may be set. In the present example, a user selects (ii) a condition (indicated by a black circle) except for date and time from the input device 18, and sets a condition such as “UNTIL UPDATE OF MAIN DOCUMENT A”. The main document A corresponds to the partial electronic information. When the version of the main document A is updated, the update determining unit 26 determines that the version of the electronic information group is updated and the judgment unit 28 judges that the attached document 1 is not included in the electronic information group. In the present example, the setting content of the condition information is represented by term limit. Accordingly, the state of the attached document 1 that is not included in the electronic information group having the updated version is changed to be expired by the result applying unit 30.

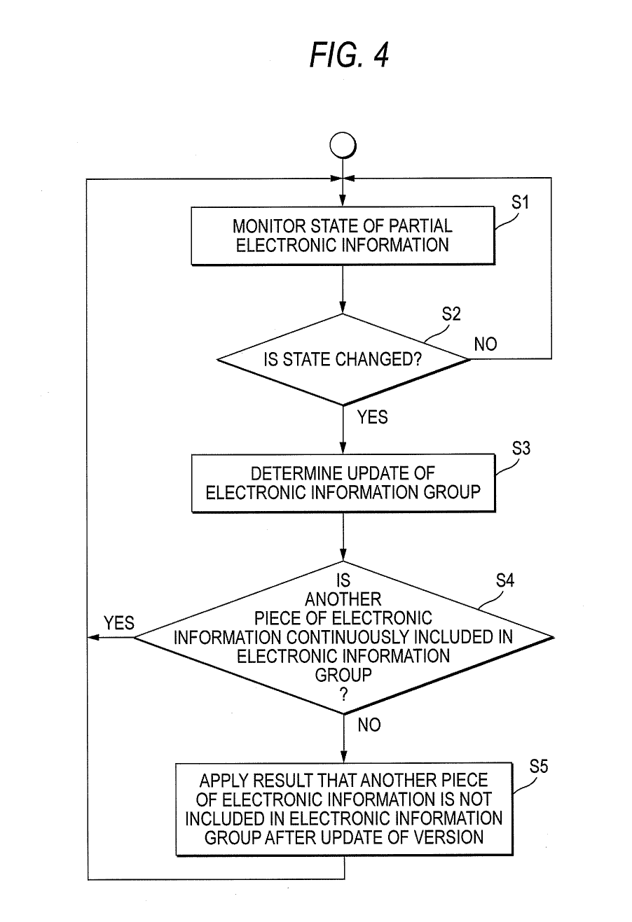

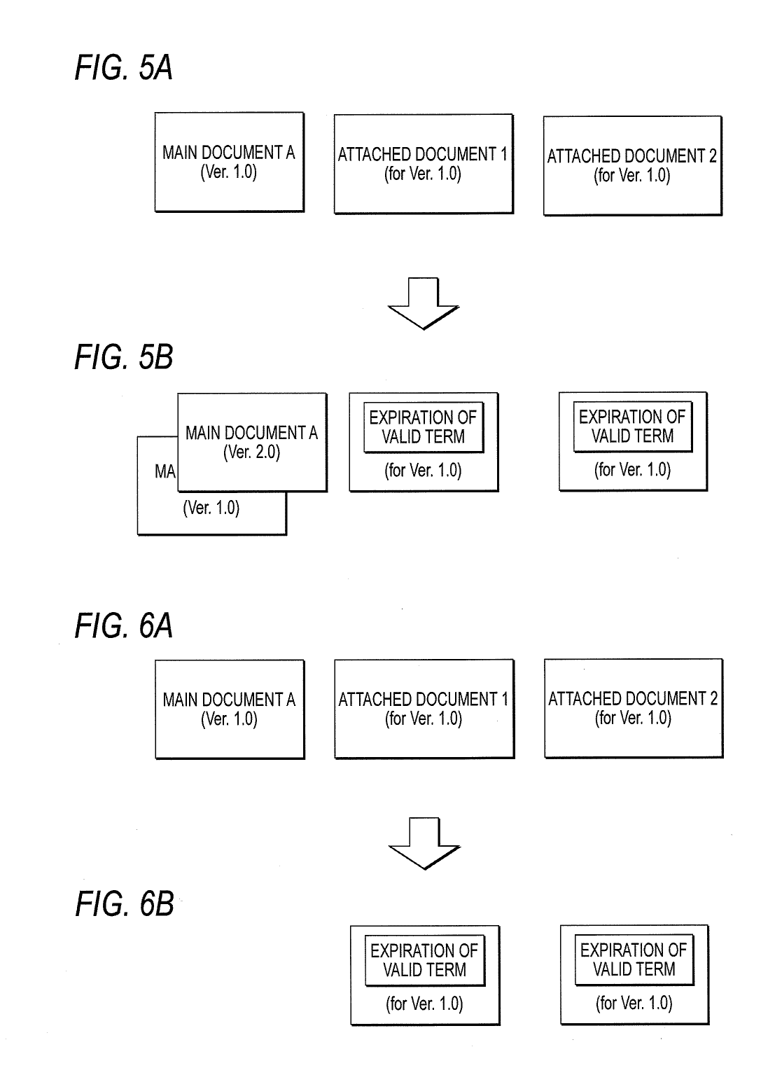

FIG. 4 shows a flowchart of an operation example of the information management apparatus according to the invention. FIGS. 5A and 5B show a diagram illustrating the electronic information group.

In FIG. 4, the update determining unit 26 monitors a state of partial electronic information included in an electronic information group which includes pieces of electronic information (S1).

For example, in the example shown in FIG. 5A, the electronic information group includes one main document A and two attached documents 1 and 2 (all of them are computerized document information), and the main document A corresponds to the partial electronic information. In the main document A, version information is set as state information. In the example shown in FIG. 5A, the version information is “Ver. 1.0 (First Version)”. In each of the attached documents 1 and 2 as the another piece of electronic information, condition information is set as “for Ver. 1.0”, which means that the attached documents 1 and 2 are documents for Ver. 1.0 of the main document A, and section that the attached documents 1 and 2 are not included in the electronic information group when the version of the main document A is updated. That the attached documents 1 and 2 are not included in the electronic information group means that the valid term of the attached documents 1 and 2 expires or the attached documents 1 and 2 are deleted, but it is not limited thereto. The state of “not included” may be appropriately set according to use purpose of the information management apparatus.

As described above, the electronic information is changed by the update processing unit 32 on the basis of the instruction information input from the input device 18 by a user, and state information thereabout is created. Accordingly, the update determining unit 26 monitors whether or not a state of partial electronic information is changed (S2). When the state of the partial electronic information is changed, it is determined that the version of the electronic information group including the electronic information is updated (S3).

In the example shown in FIG. 5B, the version information of the main document A is changed from Ver. 1.0 to Ver. 2.0, and the state of the main document A is changed. For this reason, the update determining unit 26 judges that the version of the electronic information group is updated.

Then, the judgment unit 28 judges whether or not the another piece of electronic information included in the electronic information group before updating the version is still included in the electronic information group after updating the version (S4). When it is judged that the another piece of electronic information is included therein in the step S4, the steps are repeated from the step S1. When it is judged that the another piece of electronic information is not included therein, the result applying unit 30 applies the judgment result of the judgment unit 28 that the information is not included therein, to the state information of the another piece of electronic information (S5), the steps are repeated from the step S1.

As shown in FIG. 5B, in the attached documents 1 and 2, the condition information is set as “for Ver. 1.0”. In this case, when expiration of a valid term is set as the judgment result applying method of the judgment unit 28 in the condition information, “valid term expiration” is set as the state information of the attached documents 1 and 2 by the result applying unit 30 as shown in FIG. 5B. At this time, “valid term expiration” is displayed on the display device 20.

FIGS. 6A and B show another diagram illustrating the electronic information group. In the present example, the main document A as the partial electronic information shown in FIG. 6A is deleted as shown in FIG. 6B. In this case, the update processing unit 32 deletes the main document A, and outputs state information about the deletion to the update determining unit 26. The update determining unit 26 monitors change in state of deleting the main document A on the basis of the state information output from the update processing unit 32, and determines that the version of the electronic information group is updated.

In the present example, the condition information is also set as “for Ver. 1.0”, and thus each of the attached documents 1 and 2 as the another piece of electronic information is not included in the electronic information group, by updating the version of the electronic information group. As a result, in the present example similarly with FIG. 5B, “valid term expiration” is set as the state information of the attached documents 1 and 2 by the result applying unit 30.

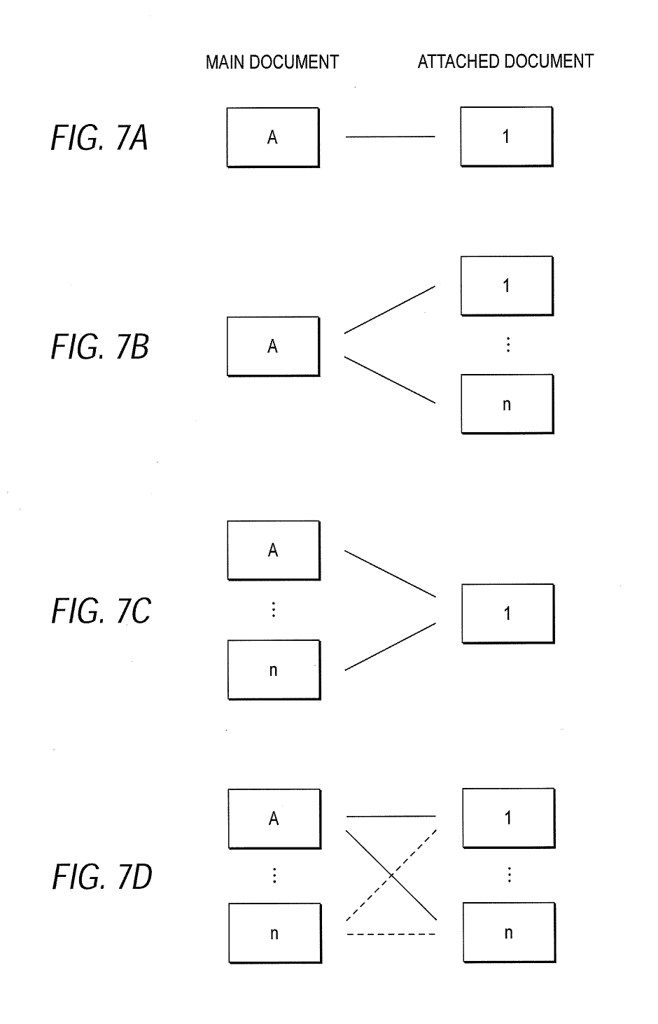

FIGS. 7A, B, C and D additionally show another diagram illustrating the electronic information group. In the present example, the electronic information group includes a main document and an attached document, and numerical relation thereof is different.

That is, in the example shown in FIG. 7A, the main document and the attached document are in a relation of one to one. In the example shown in FIG. 7B, the main document and the attached documents are in a relation of one to plurality. In the example shown in FIG. 7C, the main documents and the attached document are in a relation of plurality to one. In the example shown in FIG. 7D, the main documents and the attached documents are in a relation of plurality to plurality.

In any case, the update determining unit 26 determines whether or not the version of the electronic information group is updated, on the basis of a state of one or more main documents. When the version is updated, the judgment unit 28 judges whether or not one or more attached documents are still included in the electronic information group. The result applying unit 30 applies the judgment result to the attached documents, and the application result is displayed on the display device 20.

In case of the plurality of main documents (FIGS. 7C and D), the update determining unit 26 determines whether or not the electronic information group is updated for each state of the main documents. Accordingly, in case of the plurality of main documents, electronic information groups are formed as many as the number of main documents. For this reason, the judgment unit 28 makes a judgment with respect to each of the main documents, and it is judged whether or not the attached document is included in the electronic information groups of each main document.

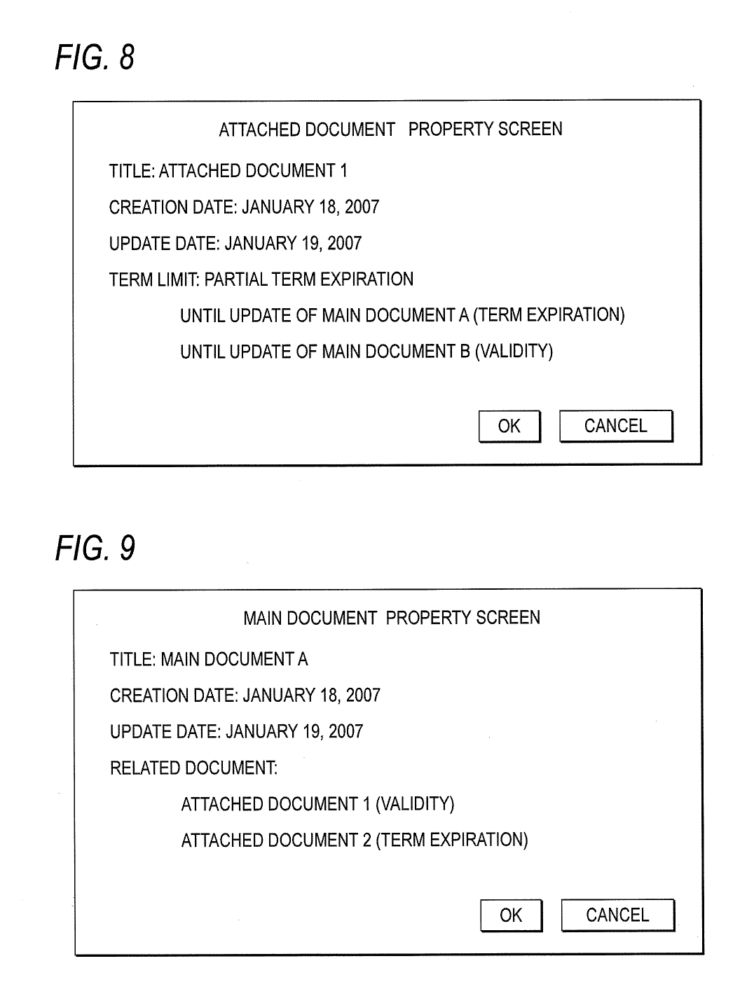

FIG. 8 shows a display example in case of applying the judgment result of the judgment unit 28 to the plurality of main documents shown in FIG. 7C. In the example shown in FIG. 8, there are two main documents (A, B), there is one attached document (attached document 1), the main documents and the attached document are in a relation of plurality to one as shown in FIG. 7C. As shown in FIG. 8, in the attached document 1 that is a display target, condition information such as “UNTIL UPDATE” is set for each of the main documents A and B. In the present exemplary embodiment, since the version of the main document A is updated and the version of the main document B is not updated, the attached document 1 is not included in the electronic information group (displayed as term expiration) since it is determined that the version of the electronic information group including the main document A is updated, and the attached document 1 is still included in the electronic information group (displayed as validity) since the version of the electronic information group including the main document B.

FIG. 9 shows a display example in case of applying the judgment result of the judgment unit 28 in the electronic information group including a plurality of attached documents. In the example shown in FIG. 9, there is one main document A, there are two attached documents (attached documents 1 and 2), and the main document and the attached documents are in a relation of one to plurality as shown in FIG. 7B. In FIG. 9, condition information such as “UNTIL DELETION OF MAIN DOCUMENT A” is set in the attached document 1, and condition information such as “UNTIL UPDATE OF MAIN DOCUMENT A” is set in the attached document 2.

When the main document A is updated, it is determined that the version of the electronic information group is updated and it is judged that the attached document 2 is not included in the electronic information group, thereby displaying term expiration. Meanwhile, it is judged that the attached document 1 is still included in the electronic information group, thereby displaying validity.

The foregoing description of the exemplary embodiments of the present invention has been provided for the purposes of illustration and description. It is not intended to be exhaustive or to limit the invention to the precise forms disclosed. Obviously, many modifications and variations will be apparent to practitioners skilled in the art. The embodiments were chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. A computer readable medium storing a program causing a computer to execute a process for managing an electronic information group which includes a first piece and a second piece of electronic information, the process comprising:
monitoring state information indicating a state of the first piece of electronic information;
determining that a version of the electronic information group is updated when the state indicated by the state information is changed;
judging whether the second piece of electronic information is included in the electronic information group which has the updated version or not, when determining that the version of the electronic information group is updated; and
applying the judgment result to state information indicating a state of the second piece of electronic information.

2. The computer readable medium according to claim 1,
wherein the second piece of electronic information includes condition information indicating a condition that the second piece of electronic information is not included in the electronic information group, and
the condition is set based on the state information of the first piece of electronic information.

3. The computer readable medium according to claim 1,
wherein the state information of the first piece of electronic information includes a version thereof, a valid term thereof, and delete information whether the first piece of electronic information is deleted or not.

4. The computer readable medium according to claim 1,
wherein the state information of the second piece electronic information to which the judgment result is applied, includes expiration of a valid term.

5. An information managing method for managing an electronic information group which includes a first piece and a second piece of electronic information, the method comprising:
monitoring state information indicating a state of the first piece of electronic information;
determining that a version of the electronic information group is updated when the state indicated by the state information is changed;
judging whether the second piece of electronic information is included in the electronic information group which has the updated version or not, when determining that the version of the electronic information group is updated; and
applying the judgment result to state information indicating a state of the second piece of electronic information.

6. An information management apparatus for managing an electronic information group which includes a first piece and a second piece of electronic information, comprising:
an update section that monitors state information indicating a state of the first piece of electronic information;
a judgment section that (i) determines that a version of the electronic information group is updated when the state indicated by the state information is changed and (ii) judges whether the second piece of electronic information is included in the electronic information group which has the updated version or not, when the judgment section determines that the version of the electronic information group is updated; and
a result applying section that apples the judgment result to state information indicating a state of the second piece of electronic information.
